(19) United States
(12) Patent Application Publication
(10) Pub. No.: US 2026/0239262 A1
(43) Pub. Date: Aug. 13, 2026

(54) Store and Forward Satellite Operation

(71) Applicant: Apple Inc., Cupertino, CA (US)

(72) Inventors: Vivek G. Gupta, San Jose, CA (US); Haijing Hu, Los Gatos, CA (US); Sridhar Prakasam, Fremont, CA (US)

(21) Appl. No.: 19/460,453

(22) Filed: Jan. 27, 2026

Related U.S. Application Data
(60) Provisional application No. 63/756,031, filed on Feb. 7, 2025.

(51) Int. Cl. H04W 60/04; H04W 8/04; H04W 8/22; H04W 64/00; H04W 84/06

(52) U.S. Cl. CPC H04W 60/04; H04W 8/04; H04W 8/22; H04W 64/00; H04W 84/06

(57) ABSTRACT

Systems and method are configured for operations comprising receiving, from an access node, an indication of store and forward capability; sending, to a satellite, an attach request message indicating a capability to support store and forward operation and an attach request; and receiving, from the satellite, a response message indicating that the attach request is accepted or that the attach request is rejected.

### CROSS-REFERENCE TO RELATED APPLICATIONS

This application claims priority to and the benefit of U.S. Provisional Patent Application No. 63/756,031, filed Feb. 7, 2025, the entire contents of which is incorporated herein by reference.

### TECHNICAL FIELD

The present disclosure relates to wireless communications.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using one or more wireless network protocols, such as protocols described in various telecommunication standards promulgated by the European Telecommunications Standards Institute (ETSI) Third Generation Partnership Project (3GPP). The wireless communication networks facilitate mobile broadband service using technologies such as orthogonal frequency-division multiple access (OFDMA), multiple-input multiple output (MIMO), advanced channel coding, massive MIMO, beamforming, and/or other features.

The non-access stratum (NAS) includes a functional layer in the NR, LTE, Universal Mobile Telecommunications System (UMTS), and Global System for Mobile Communications (GSM) wireless telecom protocol stacks between the Core Network (CN) and User Equipment (UE). NAS manages the establishment of communication sessions and maintains continuous communications with a user equipment (UE) as it moves. Once the UE establishes a radio connection, the UE uses the radio connection to communicate with core nodes to coordinate service.

### BRIEF DESCRIPTION OF THE FIGURES

FIG. 1 illustrates an example wireless network, according to some implementations.

FIG. 2 includes an illustration of a split mobility management entity (MME) architecture for store and forward satellite operation.

FIG. 3 includes an illustration of an architecture in which a full CN is onboard a satellite.

FIGS. 4-10 each illustrates an example process for a store and forward satellite operation.

FIG. 11 illustrates an example method for store and forward satellite operation.

FIG. 12 illustrates an example UE, according to some implementations.

FIG. 13 illustrates an example access node, according to some implementations.

### DETAILED DESCRIPTION

In a non-terrestrial network (NTN), a user equipment (UE) may communicate with one or more satellite base stations (also referred to as satellites or non-terrestrial access nodes) of a wireless network. In some implementations, a satellite can relay signals between the UE and one or more terrestrial access nodes. In other implementations, the UE may communicate directly with the satellite. In yet other implementations, the satellite may lose communication with the terrestrial network and may communicate with (forward information to) another satellite that is able to connect to the terrestrial network with a feeder communication link.

Due to power constraints of the satellite and the relatively large distance between the UE and the satellite, non-terrestrial communications may have lower signal quality, higher path loss, and greater latency, compared to terrestrial communications. Additionally, the satellite may intermittently lose communication with the UE. For example, coverage gaps may occur in NTN narrowband internet of things (NB-IoT) constellations. Additionally, coverage gaps can occur in low density constellations as well as in deployed constellations due to satellite outage. In a low-density low earth orbit (LEO) constellation, a service link may only be available for the time the UE is within coverage of one of the satellites. The UE may be in coverage of more than one satellite fairly rarely. The time for which the service link is available (e.g., “access duration”) may be of only 10s to few 100s of seconds and the time in-between coverage (e.g., a gap duration or revisit time) may extend up to several hours.

When coverage gaps are not handled, UEs can waste power searching for cells to monitor scheduled paging occasions that coincide with coverage gaps and on cell searches when the UE has data to transmit. In some cases, the UE may be unreachable by the network because scheduling occasions occur in coverage gaps. Furthermore, the UE may be disconnected from the network and re-attempt cell-selection and registration (NAS attach). For example, a UE that is attempting to transmit or has been scheduled to monitor paging at a certain time of day (e.g., within a coverage gap) is unable to receive transmission from a cell and would attempt to find a new cell and reattach to the network.

To mitigate the occurrence of discontinuous coverage in which the UE attempts to reattach to the network, the UE and the network can perform store and forward functions to provide autonomous service to UEs without a satellite always being connected to a gateway. The store and forward functions allow a service link access (e.g., between a satellite and a UE) to continue to be operational when a feeder link to the CN is not available or connected to the satellite.

The UE and the network can maintain coverage maps (e.g., satellite coverage maps) describing the gaps in coverage (e.g., discontinuous coverage) and schedule transmissions for when coverage is anticipated to occur. For example, in short message service contexts, each satellite may function as a short message service center (SMSC) and store a message until a feeder link is available.

The store and forward functionality can be applicable to any delay-tolerant services, such as delay-tolerate IoT services, in addition to SMS. The store and forward satellite operations help the UE avoid service degradation and extraneous UE power consumption that can occur from discontinuous coverage inherent in NTN NB-IT in the evolved packet system (EPS) and in 5GS networks. In some implementations, the NAS protocol can identify whether there is support for store and forward satellite functionality in the network and/or UE and which data are delay tolerant such that these data can be sent using store and forward functions.

In an aspect, when store and forward satellite operation is supported, the network and UE can each update their respective timers and procedures operations like attach/detach processes, tracking processes, registration update timers, mobile reachable timers, authentication and security timers, tracking area update (TAU) procedures, monitoring event occurrence and reporting, and other NAS procedures as described herein.

The UE and network can store coverage maps information for performing store and forward satellite operations. A satellite orbit can be described by initial conditions and a set of orbital parameters. A satellite almanac contains the coarse orbit and is valid for scheduling purposes. The short-term ephemeris is used for uplink synchronization and is provided in the form of two subsequent position broadcasts or the broadcast of position and velocity of the satellite. The almanac and ephemeris information are broadcast in system information blocks (SIBs) for scheduling and synchronization purposes. UEs at the edge of satellite coverage should be able to receive and decode ephemeris information within their access windows. Almanac information can be available at least once per access window. Access information can also be provided over NAS signaling during TAU/attach procedures in EPS or in the registration procedure in 5GS. A UE can use almanac-based predictions and ephemeris information to determine when satellite coverage will be available and thus optimize cell-search, PLMN selection, and connectivity with network for energy consumption. The network can provide next cell/satellite selection information or coverage gap information periodically to UE during TAU/MRU procedures to improve cell re-selection/PLMN selection procedure and reduce power consumption. In some implementations, the network can determine the UE location without relying on the UE. In another example, communication between UEs can occur without traversing a feeder link to the network. While store and forward satellite operations are described from a data service perspective for IoTNTN (EPS), similar functionality can be extended to 5GS and 6GS networks. Some aspects of the present disclosure relate to NTN storge and forward operations covering non-geosynchronous (NGSO) constellations operating in frequency range 1 (FR1)-NTN or frequency range 2 (FR2)-NTN.

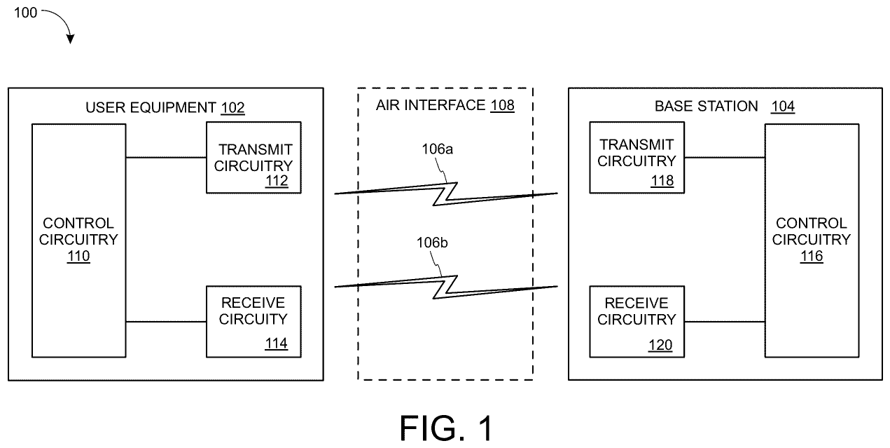

FIG. 1 illustrates an example wireless network 100, according to some implementations. The wireless network 100 includes a UE 102 and a base station 104, which are connected via one or more channels 106A, 106B across an air interface 108. The UE 102 and base station 104 communicate using a system that supports controls for managing the access of the UE 102 to a network via the base station 104.

In some implementations, the wireless network 100 is a standalone (SA) network, e.g., that incorporates fourth generation (4G) Long Term Evolution network. In some other implementations, the wireless network 100 is a non-standalone (NSA) network that incorporates Long Term Evolution (LTE) and fifth generation (5G) new radio (NR) networks. In these implementations, the wireless network 100 may be an Evolved Universal Terrestrial Radio Access (E-UTRA) NR dual connectivity (EN-DC) network, or an NR-EUTRA dual connectivity (NE-DC) network. Furthermore, wireless networks implementing one or more other types of communication standards are possible, including future 3GPP systems (e.g., sixth generation “6G”), Institute of Electrical and Electronics Engineers (IEEE) 802.11 technology, or the like. While aspects may be described herein using terminology commonly associated with 5G NR, aspects of the present disclosure can be applied to other systems, such as systems subsequent to 5G (e.g., 6G).

In the wireless network 100, the UE 102 and any other UE in the system may be, for example, any of a laptop computer, smartphone, tablet computer, machine-type device (such as smart meters or specialized devices for healthcare), intelligent transportation system, or any other wireless device. In the wireless network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include application-specific circuitry, baseband circuitry, or any of various combinations thereof. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and/or control circuitry 110 may be integrated in various ways to implement the operations described herein. The control circuitry 110 may be adapted or configured to perform various operations, such as those described elsewhere in this disclosure related to a UE. For example, the control circuitry 110 can determine one or more slots to monitor for repetitions of a Type-0 PDCCH transmission that schedules a PDSCH transmission carrying SIB1. As described herein, the term “slot” refers to a time interval comprising 14 orthogonal frequency division multiplexing (OFDM) symbols.

The transmit circuitry 112 can perform various operations described herein. For example, the transmit circuitry 112 can transmit an indication of whether the UE 102 supports intra-slot repetition of Type-0 PDCCH and/or PDSCH with SIB1. Additionally, the transmit circuitry 112 may transmit using a plurality of multiplexed uplink physical channels. The plurality of uplink physical channels may be multiplexed, e.g., according to time division multiplexing (TDM) or frequency division multiplexing (FDM), and in some implementations, along with carrier aggregation (CA). The transmit circuitry 112 may be configured to receive block data from the control circuitry 110 for transmission on the air interface 108.

The receive circuitry 114 can perform various operations described herein. For example, the receive circuitry 114 can receive control signaling that configures one or more parameters for Type-0 PDCCH repetition and/or PDSCH repetition. Additionally, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM, e.g., along with CA. The transmit circuitry 112 and the receive circuitry 114 may transmit and receive, respectively, both control data and content data (e.g., messages, images, video, and the like) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR wireless network 100, and the term “E-UTRAN” or the like may refer to a base station 104 that operates in an LTE wireless network 100. The UE 102 utilizes connections (or channels) 106A, 106B, each of which includes a physical communications interface or layer.

The base station 104 circuitry may include control circuitry 116 coupled (directly or indirectly) with transmit circuitry 118 and/or receive circuitry 120. The transmit circuitry 118 and receive circuitry 120 may each be coupled (directly or indirectly) with one or more antennas that may be used to enable communications via the air interface 108. The transmit circuitry 118 and receive circuitry 120 may be adapted to transmit and receive data, respectively, addressed to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as an LTE protocol, advanced LTE (LTE-A) protocol, LTE-based access to unlicensed spectrum (LTE-U), NR protocol, NR-based access to unlicensed spectrum (NR-U) protocol, and/or any other communications protocol(s). In some implementations, the UE 102 may directly exchange communication data via a ProSe interface. The ProSe interface may alternatively be referred to as a sidelink interface and may include one or more logical channels, including but not limited to a physical sidelink control channel (PSCCH), a physical sidelink discovery channel (PSDCH), and a physical sidelink broadcast channel (PSBCH).

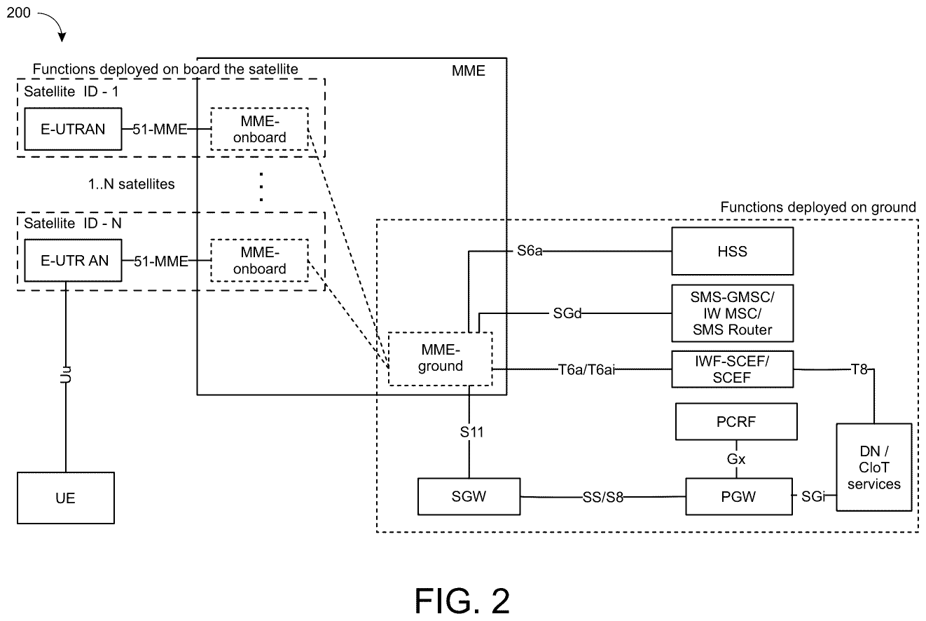

FIG. 2 includes an illustration of a split MME architecture 200 for store and forward satellite operation. The MME is configured to perform functions such as bearer management in which the MME sets up and manages data paths between the UE and the network. The MME is configured to perform security procedures such as managing security protocols, including authentication and encryption. The MME performs mobility management by tracking the UE location to ensure interoperability with other networks.

The UE location verification is performed on the satellite. For example, the serving mobile location center (SMLC) is a network element resides in the base station controller and calculates network-based location of UEs. An evolved SMLC (E-SMLC) is deployed on satellite to perform the verification of UE location functionality. Only control plane CIoT EPS optimizations apply for data transfer. The control plane CIoT EPS Optimization is a functionality to reduce the total number of control plane messages when handling a short data transaction. The user data or SMS message is conveyed to the IoT services through the MME by encapsulating them in NAS messages.

For store and forward satellite operation, the MME functionality is split into two parts. A first part includes the MME onboard the satellite. This MME part is onboard the satellite and is associated with a satellite identifier (ID). The second MME part includes the MME on the ground that performs MME functions as part of the terrestrial network (e.g., CN functions). For example, the home subscriber server (HSS) domain name system (DNS) are part of the ground MME functionality. The onboard MME-onboard(s) interacts with MME-ground and synchronizes the UE context between them so that each MME associates the UE with a same status.

When a UE initiates a mobile originated (MO) procedure that requests or uses an interaction with the core network (CN) on the ground, the MME-onboard function stores the MO procedure transaction (and MO data) if the feeder link is not available and synchronizes with the MME-ground (transfers MO data) when the feeder link becomes available. The MME-ground executes the procedure with the ground network nodes and syncs back the UE context with the MME-onboard when the feeder link becomes available.

For a mobile termination (MT) procedure, MT data is stored in the MME-ground function when the feeder link is unavailable and transferred to the MME-onboard when the feeder link becomes available. The MME-ground determines the satellite through which to send MT data. The MT data is then stored in the MME-onboard of the satellite(s) when the feeder link is available and transferred to the UE when service link becomes available.

For a MO short message service (SMS) operation, when the feeder link is not available, the MME-onboard function stores the MO-SMS and can immediately send the delivery report (e.g., a acknowledge message (RP-ACK) sent during message relay) to the UE. The MME-onboard function send the delivery report (e.g., the acknowledgement) as if the MO-SMS has already been successfully delivered to the service center (SC). Once the feeder link is established between the satellite and the network, the MO-SMS is forwarded to the SC. Subsequently, the SC sends the delivery report (RP-ACK) to the UE. The MME-ground can also discard the RP-ACK received from the SC.

From the UE perspective, it appears as though full MME functionality is available at the satellite. The interface is maintained, and the UE can send data over the UU interface, the UE sends data to the onboard MME, and the onboard MME sends data to the ground MME when the feeder link is established. The end to end communication link is then established, and data are transmitted.

For mobile originated procedures where the UE is trying to initiate some communication, so when the UE initiates mobile originated procedure, which means the interaction with the core network on the ground, the satellite stores the mobile originated data if the feeder link is not available. The onboard MME synchronizes with the MME ground when the feeder link becomes available. The MME ground executes the procedure with the ground access nodes and syncs back the UE context with the MME onboard when the feeder link becomes available. A similar process occurs for a base station to UE transmission. As described herein, the MME verifies the UE location and updates timers for the store/forward operation. For example, with satellite communication, messages can be delayed. To order (re) transmissions a timestamp can be included in every message sent by the onboard MME. The tracking of the UE location enables the onboard MME to verify, while transmissions are scheduled to occur, that the UE is still in the location in coverage (or confirm that UE has moved out of coverage). This indicates whether the onboard MME should store the data. If the data is stored for a long time and if the UE has been out of coverage, then the data is discarded.

The store and forward satellite operation mode can support multi-satellite deployment scenarios by allowing a UE to be potentially served by multiple satellites. In other words, the UE is not restricted to a single satellite within the constellation for store and forward operations. Multi-satellite support reduces the latencies in data transfer delivery, given that the revisit time of a single satellite may be around 12 hours or longer for typical orbits. The split between C-SGN-SAT and C-SGN-GND is also applicable to a multi-satellite scenario, where a single instance of C-SGN-GND on ground could interact with multiple instances of C-SGN-SAT onboard the satellites.

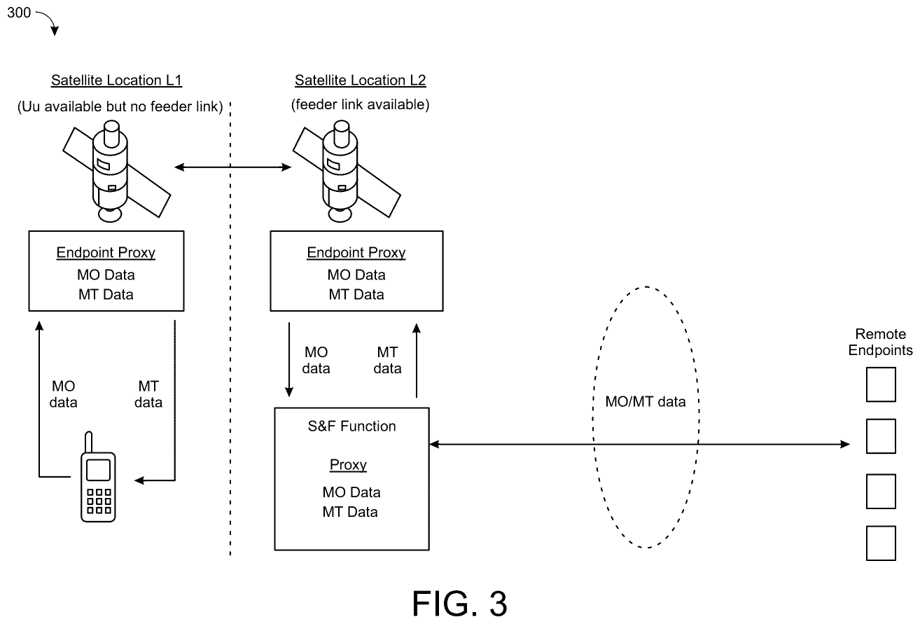

FIG. 3 includes an illustration of an architecture 300 in which a full CN is onboard a satellite. The full CN architecture can support store and forward satellite operation for SMS and CIoT services.

Each satellite contains the functionally of an eNB plus a full Evolved Packet Core (EPC) that can include an MME, Serving Gateway (SGW), Packet Data Network Gateway (PGW), HSS, E-SMLC, SMS center (SMSC), and so forth. The satellite further includes an endpoint proxy function that emulates the behavior of a real endpoint (e.g. an application function (AF)) from the perspective of a UE. There is also store and forward functionality on the ground that can be part of, or connected to, an NTN Gateway and that contains the proxy functionality.

A UE accesses and attaches to a satellite and sees the onboard eNB and EPC as being equivalent to a serving Public Land Mobile Network (PLMN) for normal operation and establishes Packet Data Network (PDN) connections to the onboard EPC for available services. The onboard EPC can obtain the UE location and verify that UE is allowed to access the selected PLMN.

A UE performs MO transactions such as sending SMS, data using user plane or control plane CIoT EPS optimizations. Each MO transaction is transferred by onboard EPC to the onboard endpoint proxy which stores transaction data and signaling and associated protocol and remote endpoint data. The onboard endpoint proxy also returns responses to the UE at a transport and application level that are necessary to allow correct transport and application protocol operation, avoid timeouts, and enable a user (if participating) to be aware of the one way communication status.

Shortly before satellite coverage is lost, the onboard EPC can detach the UE. After the UE loses coverage and when the satellite obtains a feeder link to a ground based portion of the serving PLMN selected by the UE for the attach, the satellite (or the onboard endpoint proxy) transfers all of the stored data and signaling for the UE MO transactions to a store and forward function for the serving PLMN. The store and forward function can include a proxy that stores the data and signaling for the UE MO transactions and then forwards the data and signaling for each MO transaction to the associated remote endpoint.

For the mobile termination procedure, the proxy receives and stores data and signaling for (MT) transactions that can be returned by the remote endpoints to the UE. The store and forward function and proxy can simulate continuous reachability of the UE. The MT transaction data and signaling for the UE received and stored by the proxy are transferred to one or more satellites that are expected to later provide coverage to UE. When the UE accesses and attaches to the satellite, the endpoint proxy sends MT data to the UE based on the notification from onboard EPC.

Store and forward satellite operation is suitable for delay-tolerant communication services (e.g. CIoT/MTC, SMS, etc.). If the satellite does not support store and forward satellite operation and there is no feeder link connection to the ground network, then the satellite cannot provide any service to any UEs. When both the service link and feeder link are available, all services can be provided.

To support store and forward satellite operation, some network (PLMN) functionality needs to be deployed on the satellite. In store and forward satellite operation, the end-to-end exchange of signalling/data traffic is handled depending on availability of the service link when the satellite can exchange data with the UE and of the availability of the ground link when the satellite can exchange data with the core network. The transmission of data from the UE to a server on the ground may involve two steps: a) when service link is available the UE sends the data to the satellite; b) the satellite carrying the payload connects to the ground network and delivers the UE data to the network.

When a satellite supports store and forward satellite operation and is operating in the store and forward mode, the onboard eNodeB broadcasts an indication of operating in store and forward mode which the UE uses to determine the current operation mode of the satellite. If a satellite is operating in store and forward mode, and if a UE is enabled for store and forward operation, then the UE indicates the store and forward capability during Attach and Tracking Area Update procedures. In store and forward mode operation, the eNodeB is configured to select the MME onboard the satellite which supports store and forward mode. The network indicates its capability to support store and forward operation as part of EPS network feature support IE in Attach Accept/Reject, TAU Accept/Reject messages. If network does not support store and forward, UE does not try any other operation. For split MME deployment option, system cannot support user plane establishment and user plane data transfer in store and forward mode.

The MME may indicate to UE the estimated delivery time (time to send data from UE to PDN Gateway) in NAS messages (attach accept message, TAU accept message, or service accept message). The MME and HSS (on the ground) exchange messages to fetch subscription and other information. The MME may include timestamp information in these messages that can be used by HSS to ensure that message interactions with MME are handled in correct order. When UE loses feeder link, the onboard satellite stores the data until feeder link is available. Similarly, the ground NTN Gateway stores data until satellite coverage is available.

The process updates for MME selection are now described. In store and forward mode operation, the eNodeB is configured to select the MME onboard the satellite which supports store and forward mode. For the initial attach procedure, if the UE indicated “S&F Capability” in the UE Core Network Capability, the MME may reject the Attach Request and provide the UE with a cause indicating that the UE cannot be provided with store and forward by the satellite. The MME may optionally include a store and forward Wait Timer, a store and forward Monitoring List, or both, in the Attach Reject message. The UE starts the SF_WaitTimer and waits for the timer to expire. In some implementations, the UE can search for another satellite.

A process can update the tracking area with a serving gateway change. If the UE indicates “S&F Capability” in the UE Core Network Capability, the MME is operating in store and forward mode. If the MME rejects the TAU Request, the MME may provide a reason that indicates that store and forward operation is not supported by the satellite at this time. In some implementations, the UE may be provided with a store and forward wait timer, or a store and forward monitoring list (or both) because of authentication failure and other issues.

When the UE indicates “S&F Capability” in the UE Core Network Capability and the MME is operating in store and forward Mode, the MME proceeds as follows. If the MME has rejected the UE request based on configuration, the MME may send an Update Location Request including an indication. If the MME has accepted the UE request the MME sends an Update Location Request that may include a timestamp. The absence of timestamp in the Update Location Request implies that the UE is connecting from a network that does not operation in store and forward mode.

Mobile originated (MO) data transport in Control Plane CIoT EPS optimization with packet gateway (P-GW) connectivity is now described. If the UE indicates “S&F Capability” in the UE Core Network Capability, and the MME is operating in store and forward mode, if the MME rejects the NAS PDU, the MME can provide a cause that indicates that store and forward operation is not supported by the satellite at this time. Optionally, the UE may be provided with a store and forward Wait Timer, a store and forward monitoring list, or both.

Store and forward satellite operation can include updates to NAS times. The MME can adapt a periodic registration update timer and implicit detach timer when the UE is operating in store and forward mode. The periodic registration timer (T3312) is started by the UE when the UE moves to the idle state. The UE initiates mobile and periodic registration on expiry. In an example, the default timer value is 54 minutes.

A mobile reachable timer is started by the MME starts when the UE moves to the idle state. The mobile reachable timer has value larger than the periodic registration timer. On expiry of the timer, the MME determines that the UE is unreachable. The timer value is 4 minutes greater than the periodic registration timer.

An implicit de-registration timer is used when the UE is unreachable. If the UE is unreachable, the MME starts the implicit de-registration timer (with a relatively large value) and clears the paging proceed flag (PPF). If the de-registration timer expires before the UE contacts the MME, the MME deregisters the UE and releases all PDU sessions. In some implementations, the de-registration timer value is 4 minutes greater than the periodic registration timer.

The satellite (e.g., the gNB and onboard MME) indicate a timer value which the UE uses to suspend the related procedure timers. This occurs for stopping of attach, TAU, authenticate, and service request timers if the feeder link is not available when using split MME.

The UE can indicate a capability regarding whether the UE supports store and forward operation. Store and forward operations are applicable for both data and registration procedures. SIB information broadcasted by the satellite can include the store and forward-supported information. In some implementations, the network sends a rejection message if the UE does not support store and forward operations and the network supports store and forward operations.

Monitoring list and SCS/AS functionality are now described. The SCS/AS may determine that a UE is operating in the store and forward mode. The EPS may provide SCS/AS with related timing information (e.g., about delay in message delivery, intermittent availability of UE etc.) to guide the SCS/AS decision regarding when to try to contact the UE.

Store and forward monitoring events enable monitoring of specific events in 3GPP systems and making such monitoring events information available through the SCEF. The network can determine or identify a 3GPP network element suitable for configuring the specific events, the event detection, and the event reporting to the authorized users (e.g. for use by applications or logging, etc.). If such an event is detected, the network can perform special actions, such as limiting UE access. Examples of such events include; UE Reachability, location of the UE or change in location, loss of connectivity, communication failure, and so forth.

A monitoring event for store and forward satellite operation can allows the SCS/AS to be notified of store and forward satellite operation information, identified by EPS. The SCS/AS sets the monitoring type to “Store and Forward Satellite operation information” prior to sending monitoring request to the SCEF in the monitoring event configuration and deletion via HSS procedure.

A reporting event for store and forward satellite operation information and report information based on the monitoring event. When the MME detects that the UE is registered in store and forward mode or moving from store and forward mode to not registered in store and forward mode, the event may trigger reporting. In some implementations, the MME sends information to the SCS/AS indicating that a UE is registered in store and forward mode or is moving from store and forward mode to not being registered in store and forward mode. The MME sends to the UE information indicating a downlink store and forward estimated delivery time. The downlink store and forward estimated delivery time is the estimated/expected time required to deliver the data to the UE from the time data has been received in the network.

A satellite list, discussed previously, is a recommended list of satellites. The satellite list assists the UE to transitioning from non-store and forward mode to store and forward mode (and vice versa). The satellite list assists the UE with saving power and determining with which satellites to synchronize data. The UE can use the list to (re) attempt NAS procedures. The satellite list indicates which satellites may include MT data. The satellite list is used by the network to guide the UEs to synchronize with satellites that may have MT data allowing the network to save resources.

The MME sends S&F Monitoring list to UE and UE behavior is based on UE implementation to determine which satellites to access. For example, if the UE determines a satellite is operating in S&F Mode, the UE may follow the S&F Monitoring List to ensure a successful access; if the UE determines a satellite is not operating in S&F Mode, the UE can access to this satellite even if the UE is not in the S&F Monitoring List.

The satellites included in the satellite list are expected to be able to support the UE (e.g. have a UE context) and must support store-and-forward operation (but may be operating in normal IoT NTN mode or in store-and-forward mode when the satellite serves the area where the UE is located).

A monitoring event can occur when the UE moves from a non-store and forward mode to the store and forward mode. The UE initiates a TAU procedure which includes a GUTI (e.g. the UE moves out of the tracking area identifier (TAI) list). In some implementations, the UE initiates a service request procedure to trigger the event. The store and forward MME may have UE context information in the in TAU procedure. The MME may not be cable to retrieve the UE context information from the old MME because the UE context in the old MME is not reachable (e.g., there is no feeder link). In this case, the MME sends a message that indicates that the UE identity cannot be derived by the network, rather than a store and forward wait timer report, to the UE.

A monitoring event can occur when the UE moves from a store and forward mode to a non-store and forward mode. The UE initiates the TAU procedure which includes the GUTI (such that the UE moves out of TAI list). Alternatively, the UE initiates a service request procedure. If the MME does not have the latest UE context information, the MME can indicate that a “UE identity cannot be derived by the network” to cause the UE to initiate the attach procedure.

UE behavior responsive to receiving the satellite list is now described. The UE can use the satellite list to (re) attempt NAS procedures. The UE can use the satellite list to be aware of which satellite(s) may contain MT data. The network can synchronize the UE context to the satellite(s) included in the list and can send MT data to these satellite(s). The list sent to UE is a recommendation information for UE. In some implementations, it is unnecessary to send two different lists to the UE.

How UE specifically behaves when receiving the satellite list is up to UE implementation. For example, the UE may access other satellites which are not included in the satellite list, or other RAT type to attain services. The satellites included in the satellite list are expected to be able to support the UE (e.g. have a UE context) and must support store-and-forward operation (but may be operating in normal IoT NTN mode or in store-and-forward mode when the satellite serves the area where the UE is located). In some implementations, the UE initiates an attach procedure when transitioning from non-store and forward mode to the store and forward mode.

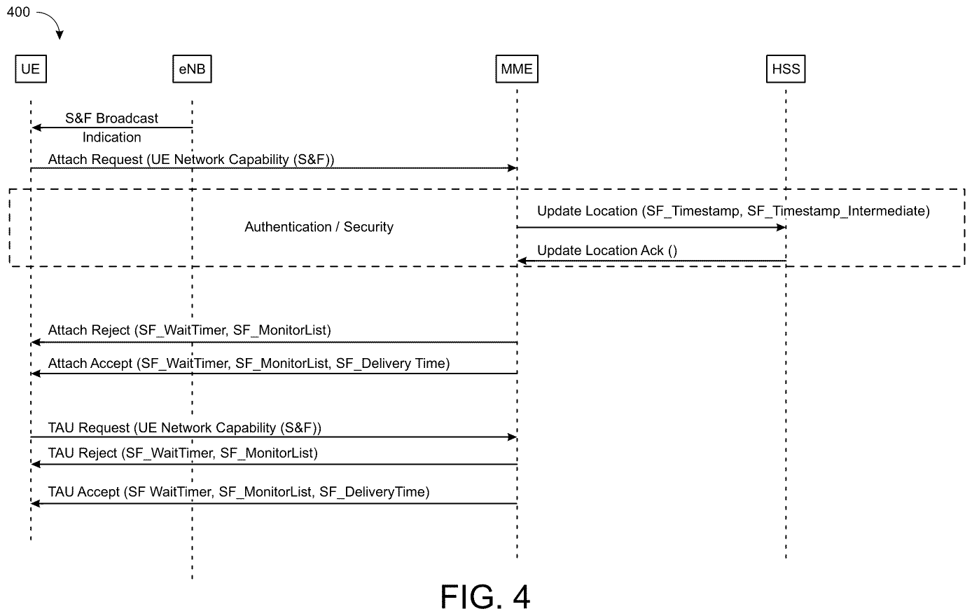

Processes for store and forward satellite operations are now described in reference to FIGS. 4-10. FIG. 4 includes a process 400 for performing satellite store and forward operation. An access node (e.g., an eNB) send a store and forward broadcast indication message to a UE. The UE generates an attach request that includes the UE network capability IE for store and forward information, as subsequently described, to the MME aboard the satellite. As previously described, the MME can be a split-MME architecture or a single MME architecture. An authentication/security process is performed between the MME and the HSS to authenticate the UE and attach the UE to the network. The MME sends information including the UE location to the HSS. The information includes the storage forward time stamp information corresponding to the attach request. The HSS sends a response to the MME acknowledging the location update. As previously discussed, the UE location is tracked to ensure coverage and for the network (MME) to understand when UE data are being stored/forwarded and when the end-to-end communication is available. The MME sends a response to the UE. The response can either reject the store and forward attach request (indicating the store and forward wait time and monitoring list) or accept the store and forward attach request (further indicating a delivery time). The UE sends, to the MME, a TAU request including the UE and network capability IE for the store and forward operation. The MME sends a response to the UE. The response can either reject the store and forward TAU request (indicating the store and forward wait time and monitoring list) or accept the store and forward TAU request (further indicating a delivery time).

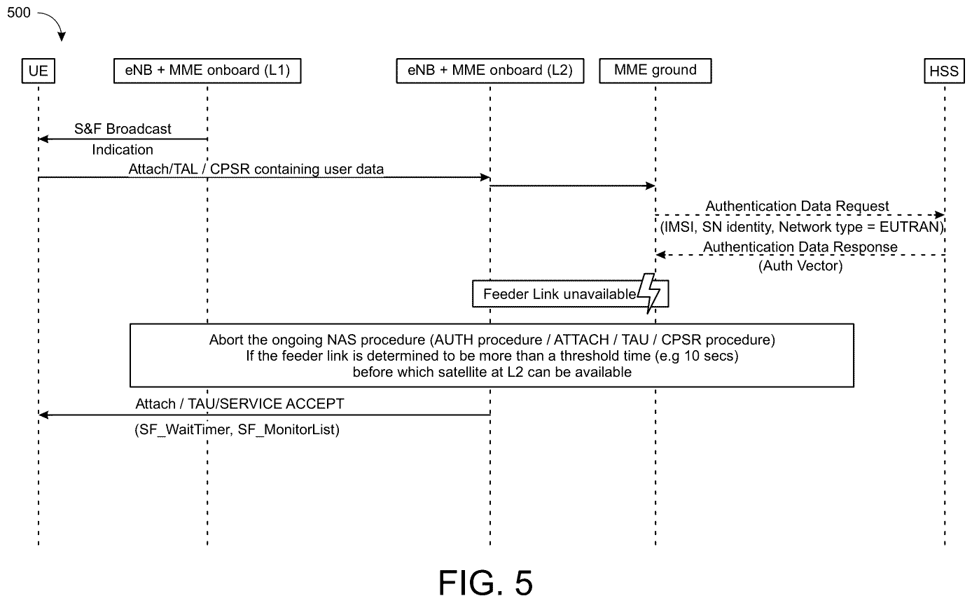

FIG. 5 includes a process 500 for store and forward operation using a split MME architecture, described in relation to FIG. 2. The access node (e.g., an eNB and MME onboard the satellite, location 1 (L1)) sends a store and forward broadcast indication to the UE. The UE sends an attach request, TAU request, or CPSR including user data to the onboard MME (location 2, L2). The onboard MME (L2) sends the request to the ground MME. The ground MME performs the CN functions for authenticating the UE by sending an authentication request to the HSS as previously described. The authentication request can include an IMSI, SN identity, and network type (ETRAN) identifier. The HSS responds to the ground MME with an authentication vector. If a feeder link is not available to the onboard MME, the ground MME aborts the ongoing NAS procedure (authentication, attach, TAU, or CPSR procedure) if the feeder link will not be reestablished (or become available) within a threshold amount of time (e.g., the L2 satellite will not be available within 10 seconds). If the feeder link is not available, a reject message is sent from the onboard MME to the UE. If UE receives a rejection message for the request (attach/TAU/CPSR) and the cause indicates that the feeder link is not available, the UE aborts the authentication procedure (if ongoing) and does not send any authentication response to the network or waits for another authentication request from network. If authentication failure occurs, the UE does not increase the attempt counter for the ongoing procedure (attach or TAU). The UE waits for the SF_waitTimer duration. When the timer expires, the UE re-attempts the attach/TAU procedure. Else, when the feeder link is available, the L2 MME sends the response to the UE (e.g., accepting the attach request, TAU request, etc.) as described previously.

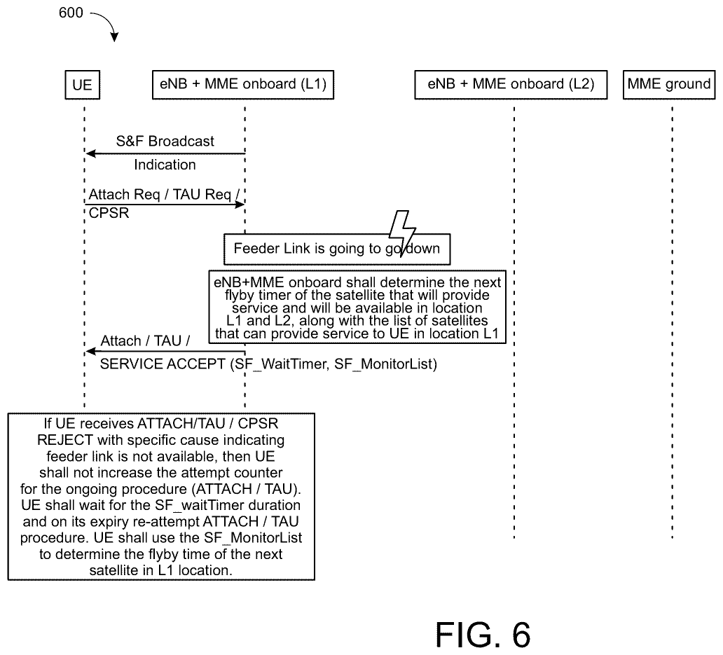

FIG. 6 illustrates an example process 600 for store and forward satellite operation in using a split MME in which the UE aborts a process. The access node (e.g., an eNB and MME onboard the satellite, L1) sends a store and forward broadcast indication to the UE. The UE sends an attach request, TAU request, or CPSR including user data to the onboard MME (L1). The onboard MME L1 determines (e.g., via a timer) that a feeder link to the network is about to become unavailable. The onboard MME (L1) determines a next flyby time of the satellite that will provide service and will be available in location L1 and L2, along with the list of satellites that can provide service to UE in location L1. The onboard MME (L1) sends an attach or TAU service accept message indicating the store and forward timer and wait timer information. If the UE receives an attach/TAU/CPSR reject message that indicates that the feeder link is not available, the UE does not increase an attempt counter for the ongoing procedure (e.g., attach or TAU). The UE waits for the SF_waitTimer duration. When the timer expires, the UE re-attempts the attach/TAU procedure. The UE uses the SF_MonitorList to determine the flyby time of the next satellite in L1 location, as described herein.

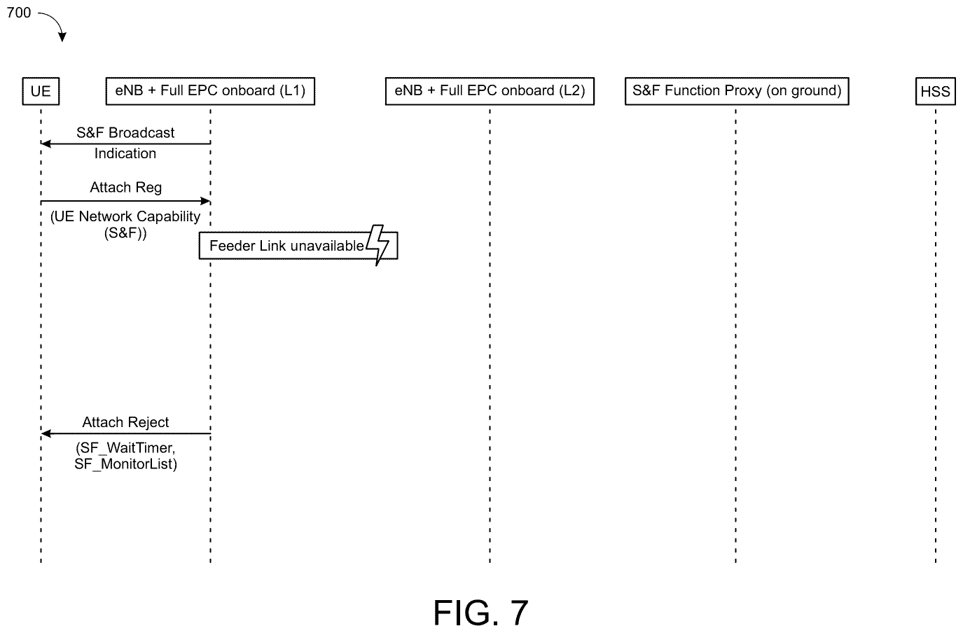

FIG. 7 illustrates an example process 700 for store and forward satellite operation in which the satellite includes a full EPC (as described in relation to FIG. 3), and for which the NAS procedure is interrupted. The access node (e.g., an eNB and full EPC onboard the satellite, location 1 (L1)) sends a store and forward broadcast indication to the UE. The UE sends an attach request including the UE network capability IE indicating the store and forward capability of the UE, as subsequently described. In this example process 700, the feeder link to the ground network is not available. The satellite does not have the UE context in this example, (this is a first time UE attach request). The EPC on the satellite will fetch authentication vectors from the HSS on ground, as described in relation to FIG. 5, before accepting the attach request. The EPC therefore rejects the attach request, specifying the store and forward timer and wait timer information to the UE. In some implementations, the EPC determines that the feeder link will become available after more than a threshold time (e.g., 10 seconds) and before which satellite at L2 can be available. In this case, the satellite at L1 keeps the procedure pending and does not reject the UE initiated request.

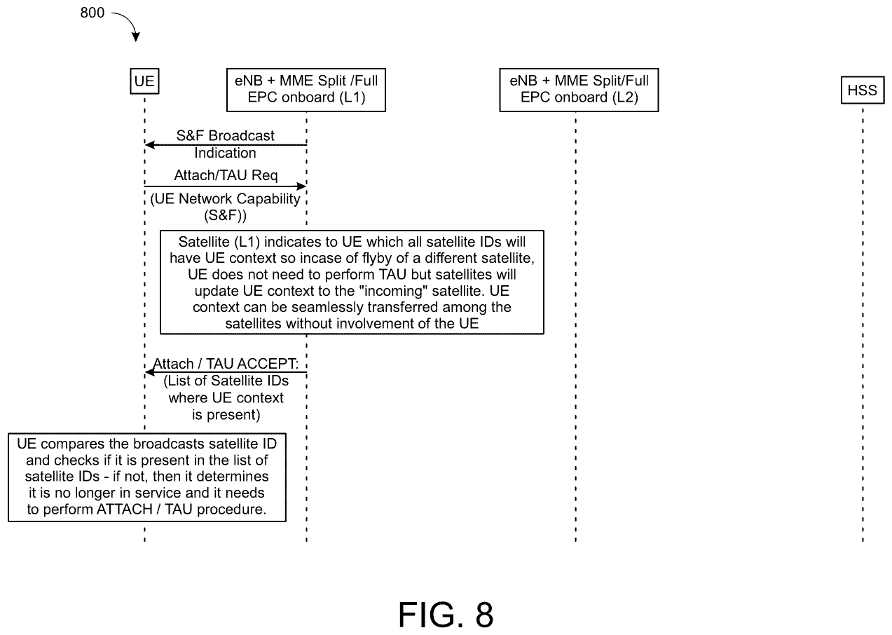

FIG. 8 illustrates an example process 800 for store and forward satellite operation in using a split MME or full EPC onboard the satellite in which the TAU is minimized. The access node (e.g., an eNB and full EPC onboard the satellite or split MME onboard the satellite, location 1 (L1)) sends a store and forward broadcast indication to the UE. The UE sends an attach/TAU request including the UE network capability IE indicating the store and forward capability of the UE, as described herein. In this example, the satellite (L1) indicates to the UE which satellite IDs already have the UE context. In case of a of flyby of a different satellite, the UE does not need to perform TAU, but satellites update UE context to the incoming satellite. UE context can be transferred among the satellites without involvement of the UE. The satellite (EPC or split MME) can send an attach response or TAU accept message including the list of satellites where UE context information is already stored. The UE compares the broadcast satellite ID and checks if it is present in the list of satellite IDs. If not, the UE determines that the UE is no longer in service and it needs to perform an attach/TAU procedure.

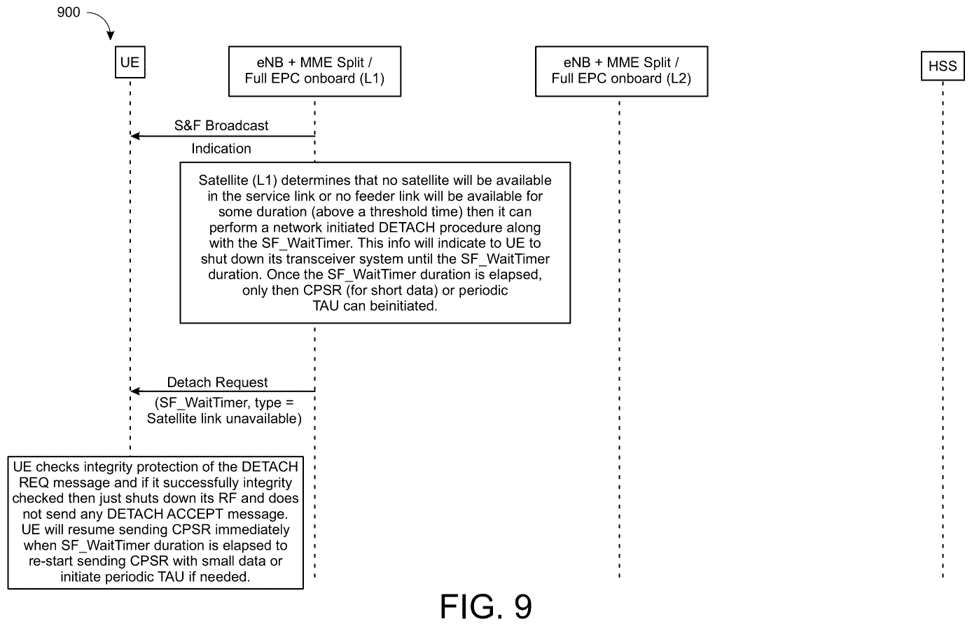

FIG. 9 illustrates an example process 900 with a network-initiated detach process (for either the full EPC satellite or split MME satellite architecture, discussed in relation to FIGS. 2-3). The access node (e.g., an eNB and full EPC onboard the satellite or split MME onboard the satellite, location 1 (L1)) sends a store and forward broadcast indication to the UE. The satellite (L1) determines that no satellite will be available in the service link, or that no feeder link will be available for some duration (above a threshold time). The satellite performs a network-initiated detach procedure along with the SF_WaitTimer. The information in detach message indicates to the UE to shut down the UE transceiver system until the SF_WaitTimer duration has elapsed. Once the SF_WaitTimer duration has elapsed, the CPSR (for short data) or periodic TAU can be initiated. The UE checks the integrity protection of the detach request message. If the check successful, the UE shuts down the UE radio/transceiver and does not send any detach accept message. The UE resumes sending the CPSR immediately when the SF_WaitTimer duration has elapsed. The CPSR is restarted with small data. Alternatively, the UE initiates periodic TAU, if needed. The UE can therefore save power.

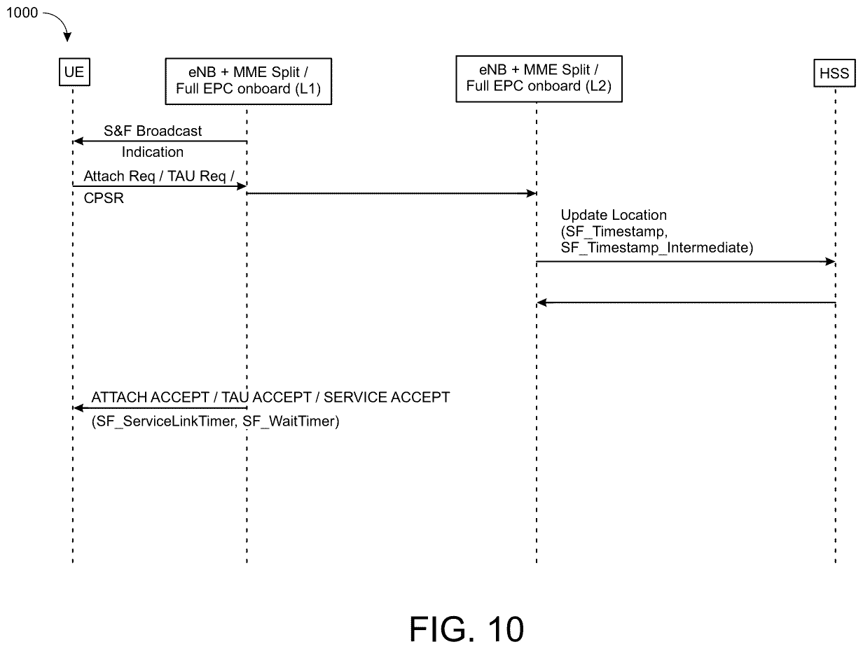

FIG. 10 illustrates an example process 1000 for a service link availability duration determination (for either the full EPC satellite or split MME satellite architecture, discussed in relation to FIGS. 2-3). The access node (e.g., an eNB and full EPC onboard the satellite or split MME onboard the satellite, location 1 (L1)) sends a store and forward broadcast indication to the UE. The UE sends an attach request/TAU request/CSPR to the L1 satellite, which can forward the request to the L2 satellite or network. The L2 satellite (or CN) sends a message indicating an updated location of the UE to the HSS, as described previously in relation to FIG. 4. The HSS acknowledges the message to the L2 satellite. The serving satellite determines for how long the UE can have an active service link. The network-provision of this value can help in cases in which satellite operators plan to tie up and provide service or new satellites are added to service UEs. In this example, the UE-maintained almanac information (previously described) will become outdated, and the UE will not be available to determine the flyby time for a new satellite which was not included in the outdated almanac. A parameter SF_ServiceLinkTimer and subsequent SF_WaitTimer are used by the UE and network to optimize signaling. These parameter values are sent with the attach accept message. Based on the values of these parameters (e.g., the SF_ServiceLinkTimer duration), the UE determines to send any CPSR including the ESM data transport including UE data or sends SMS data until the time service link is available. Once the service link is not available, the UE can start the SF_WaitTimer and switch off the UE RF for the SF_WaitTimer duration. Once the SF_WaitTimer duration is elapsed, the UE can start to send CPSR or initiate TAU or detach or re-attach as determined by UE.

A UE network capability IE for store and forward operation is now described. The UE network capability information element provides the network with information concerning aspects of the UE related to EPS or interworking with GPRS and 5GS. The contents might affect the manner in which the network handles the operation of the UE. The UE network capability information indicates general UE characteristics. The IE is independent of the frequency band of the channel the IE is sent on, except for fields explicitly indicated. The UE network capability information element is coded as shown in Table 1. In some implementations, the UE network capability IE is a type 4 information element with a minimum length of 4 octets and a maximum length of 15 octets. The requirements for the support of UMTS security algorithms in the UE are specified in 3GPP TS 33.102 [18], and the requirements for the support of EPS security algorithms in 3GPP TS 33.401 [19].

TABLE 1
Store and Forward UE network capability information element (IE)

| 8 | 7 | 6 | 5 | 4 | 3 | 2 | 1 | |
|---|---|---|---|---|---|---|---|---|
| UE network capability IEI | | | | | | | | octet 1 |
| Length of UE network capability contents | | | | | | | | octet 2 |
| EEA0 | 128- | 128- | 128- | EEA4 | EEA5 | EEA6 | EEA7 | octet 3 |
| | EEA1 | EEA2 | EEA3 | | | | | |
| EIA0 | 128- | 128- | 128- | EIA4 | EIA5 | EIA6 | EPS-UPIP | octet 4 |
| | EIA1 | EIA2 | EIA3 | | | | | |
| UEA0 | UEA1 | UEA2 | UEA3 | UEA4 | UEA5 | UEA6 | UEA7 | octet |
| | | | | | | | | 5* |
| UCS2 | UIA1 | UIA2 | UIA3 | UIA4 | UIA5 | UIA6 | UIA7 | octet |
| | | | | | | | | 6* |
| ProSe- | ProSe | H.245- | ACC- | LPP | LCS | 1xSR | NF | octet |
| dd | | ASH | CSFB | | | VCC | | 7* |
| ePCO | HC- | ERw/oPDN | S1-U | UP | CP CIoT | Prose- | ProSe-dc | octet |
| | CP | | data | CIoT | | relay | | 8* |
| | CIoT | | | | | | | |
| 15 | SGC | N1mode | DCNR | CP | RestrictEC | V2X | multipleDRB | octet |
| bearers | | | | backoff | | PC5 | | 9* |
| RPR | PIV | NCR | V2X | UP- | CP-MT- | WUSA | RACS | octet |
| | | | NR- | MT- | EDT | | | 10* |
| | | | PC5 | EDT | | | | |
| 0 | 0 | SF | RATUC | RCLIN | EDC | PTCC | PR | octet |
| Spare | Spare | | | | | | | 11* |
| 0 | 0 | 0 | 0 | 0 | 0 | 0 | 0 | octet |

| | |
|---|---|
| Spare | 12*-15* |

As seen in Table 1, the store and forward satellite operation (SF) IE is at octet 11, bit 6. In some implementations, this bit value indicates the support of store and forward satellite operation by the UE. A value (e.g., “0”) indicates store and forward satellite operation is not supported by the UE. Another bit value (e.g., “1”) can indicates that the UE supports store and forward satellite operation.

An EPS network feature support IE is now described. The EPS network feature support IE indicates whether certain features are supported by the network. The EPS network feature support information element is coded as shown in Table 2. In some implementations, the EPS network feature support is a type 4 information element with a minimum length of 3 octets and a maximum length of 5 octets. If the network does not include octet 4 or octet 5 as defined below in the present version of the protocol, then the UE shall interpret this as a receipt of an information element with all bits of octet 4 and 5 coded as zero.

TABLE 2
EPS network feature support IE

| 8 | 7 | 6 | 5 | 4 | 3 | 2 | 1 | |
|---|---|---|---|---|---|---|---|---|
| EPS network feature support IEI | | | | | | | | octet 1 |
| Length of EPS network feature support contents | | | | | | | | octet 2 |
| CP | ERw/oPDN | ESR PS | CS-LCS | | EPC- | EMC | IMS | octet 3 |
| CIoT | | | | | LCS | BS | VoPS | |
| 15 | IWKN26 | RestrictDCNR | RestrictEC | ePCO | HC- | S1-U | UP | octet |
| bearers | | | | | CP | data | CIoT | 4* |
| | | | | | CIoT | | | |
| 0 | SF | EDC | PTCC | PR | RPR | PIV | NCR | octet |
| Spare | | | | | | | | 5* |

A store and forward satellite operation (SF) indicator is included in the IE (e.g., at octet 5, bit 7). This indicator indicates the support of store and forward satellite operation by the network. A first value (e.g., “0”) indicates that store and forward satellite operation is not supported by the network. A second value (e.g., “1”) indicates that store and forward satellite operation is supported by the network.

Table 3 includes an example of an attach request message. The message is sent by the UE to perform an attach procedure and includes a representation of the UE network capability for store and forward operation.

TABLE 3
UE network capability IE for attach request

| | Information | | | | |
|---|---|---|---|---|---|
| IEI | Element | Type/Reference | Presence | Format | Length |
| | UE network | UE network capability | M | LV | 3-14 |
| | capability | 9.9.3.34 | | | |

Table 4 includes an example of an attach reject message. The message is sent by the UE to indicate that a corresponding attach request has been rejected.

TABLE 4
UE network capability IE for attach reject

| | | | Pres- | For- | |
|---|---|---|---|---|---|
| IEI | Information Element | Type/Reference | ence | mat | Length |
| | Protocol discriminator | Protocol | M | V | ½ |
| | | discriminator | | | |
| | | 9.2 | | | |
| | Security header type | Security header | M | V | ½ |
| | | type 9.3.1 | | | |
| | Attach reject message | Message type | M | V | 1 |
| | identity | 9.8 | | | |
| | EMM cause | EMM cause | M | V | 1 |
| | | 9.9.3.9 | | | |
| 78 | ESM message | ESM message | O | TLV-E | 6-n |
| | container | container | | | |
| | | 9.9.3.15 | | | |
| 5F | T3346 value | GPRS timer 2 | O | TLV | 3 |
| | | 9.9.3.16A | | | |
| 16 | T3402 value | GPRS timer 2 | O | TLV | 3 |
| | | 9.9.3.16A | | | |
| A- | Extended EMM cause | Extended | O | TV | 1 |
| | | EMM cause | | | |
| | | 9.9.3.26A | | | |
| 1C | Lower bound timer | GPRS timer 3 | O | TLV | 3 |
| | value | 9.9.3.16B | | | |
| 1D | Forbidden TAI(s) for the | Tracking area | O | TLV | 8-98 |
| | list of “forbidden | identity list | | | |
| | tracking areas for | 9.9.3.33 | | | |
| | roaming” | | | | |
| 1E | Forbidden TAI(s) for the | Tracking area | O | TLV | 8-98 |
| | list of “forbidden | identity list | | | |
| | tracking areas for | 9.9.3.33 | | | |
| | regional provision | | | | |
| | of service” | | | | |
| | SF_WaitTimer | GPRS timer 2 | O | TLV | 3 |
| | | 9.9.3.16A | | | |
| | SF_MonitorList | | O | TLV | 3-n |

Table 5 includes IEs for monitoring in store and forward satellite operation. When the SF Monitoring Event is Store and Forward satellite operation information, the SF MonitoringList content includes: a monitoring event ID (e.g., length 1 octet), a store and forward satellite operation information value of 1, and a downlink store and forward estimated delivery time parameter, as previously discussed.

TABLE 5
Monitoring List IEs

| | | | | | | | |
|---|---|---|---|---|---|---|---|
| 8 | 7 | 6 | 5 | 4 | 3 | 2 | 1 |

| SF MonitoringList IEI | octet 1 |
|---|---|
| Length of SF MonitoringList contents | octet 2 |
| | octet 3 |

Table 6 includes an example of an attach accept message. The message is sent by the UE to indicate that a corresponding attach request has been accepted.

TABLE 6
UE network capability IE for attach accept message

| | Information | | | | |
|---|---|---|---|---|---|
| IEI | Element | Type/Reference | Presence | Format | Length |
| . . . | . . . | . . . | . . . | . . . | . . . |
| 64 | EPS network | EPS network | O | TLV | 3-5 |
| | feature support | feature support | | | |
| | | 9.9.3.12A | | | |

. . .

| | | | | |
|---|---|---|---|---|
| SF_WaitTimer | GPRS timer 2 | O | TLV | 3 |
| | 9.9.3.16A | | | |
| SF_MonitorList | | O | TLV | 3-n |
| SF_DeliveryTime | GPRS timer 3 | O | TLV | 3 |
| | 9.9.3.16A | | | |
| Satellite_List | Satellite List | O | TLV | 3-n |
| | 9.9.3.16A | | | |

Table 8 includes what data are stored in the HSS. IMSI is the prime key to the data stored in the HSS. The data held in the HSS is defined in Table 8 below. Table 8 is applicable to E-UTRAN in stand-alone operation only.

TABLE 8
HSS Data for Store and Forward Satellite Operations

| | |
|---|---|
| SF_Timestamp | The time the last Update Location Request was |
| | received used when a HSS supports Store and |
| | Forward Satellite Operation to ensure the |
| | correct handling of Update Location Request |
| SF_Timestamp_{—} | Indicates the latest Update Location Request that the |
| Intermediate | HSS received for a UE was intermediate |

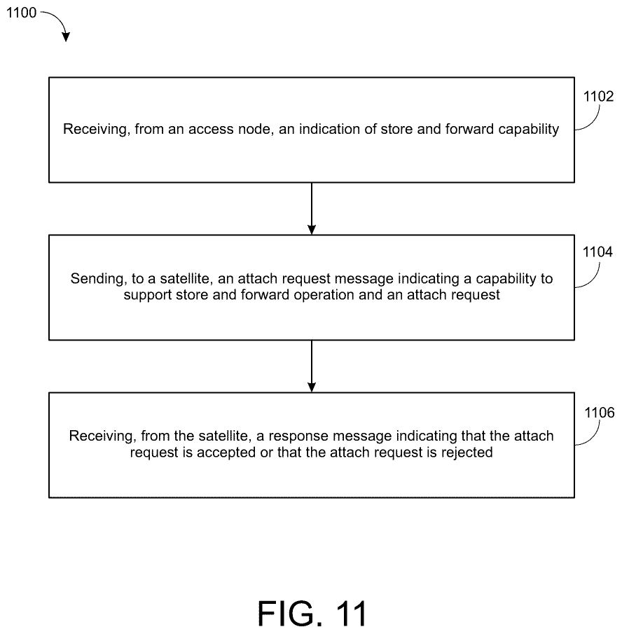

FIG. 11 illustrates a flowchart of an example method 1100 for store and forward satellite operation. For clarity of presentation, the method 1100 is described in the context of the preceding figures. For example, the method 1100 can be performed by a UE (such as the UE 102 of FIG. 1), or any suitable system, environment, software, hardware, or combination thereof. In some implementations, operations of the method 1100 can be run in parallel, in combination, in loops, or in any order. The example method 1100 shown in FIG. 11 can be modified or reconfigured to include additional, fewer, or different steps (not shown in FIG. 11), which can be performed in the order shown or in a different order.

The method 1100 includes receiving (1102), from an access node, an indication of store and forward capability; sending (1104), to a satellite, an attach request message indicating a capability to support store and forward operation and an attach request; and receiving (1106), from the satellite, a response message indicating that the attach request is accepted or that the attach request is rejected.

In some implementations, when the attach request is accepted, a attach accept response message includes a store and forward wait timer value, a store and forward event monitor list, and a store and forward delivery time.

In some implementations, when the attach request is rejected, a attach reject response message includes a store and forward wait timer value and a store and forward event monitor list.

In some implementations, the method 1100 includes sending, when the attach request is accepted, a tracking area update (TAU) request message, including a TAU request, to the satellite; and receiving a TAU response message indicating that the TAU request is accepted or that the TAU request is rejected.

In some implementations, the satellite includes an onboard mobility management entity (MME) configured to communicate with a ground MME, and wherein the ground MME is configured to perform core network (CN) functionality. In some implementations, the ground MME is configured to update a home subscriber service (HSS) with a location of a user equipment (UE).

In some implementations, the ground MME is configured to authenticate a UE.

In some implementations, the response message indicates that the attach request, a TAU request, or a CPSR message including device information is rejected because a feeder link is not available within a threshold period of time, and wherein the method 1100 includes aborting authentication; and waiting for a store and forward attach timer to expire before attempting to re-attach to a network including the MME.

In some implementations, the response message indicates a next fly by time of a satellite for providing service at a location, and the method 1100 includes determining a flyby time of the next satellite at the location based on the flyby time of the satellite.

In some implementations, the response message indicates a list of satellites that will be available for providing service at a location, and the method 1100 includes determining a flyby time of the next satellite at the location based on a flyby timer of the satellite.

In some implementations, the satellite includes a full evolved packet core (EPC) function.

In some implementations, the response message indicates that the attach request, a TAU request, or a CPSR message including device information is rejected because a feeder link is not available within a threshold period of time, and the method 1100 further includes aborting authentication; and waiting for a store and forward attach timer to expire before attempting to re-attach to a network including the EPC.

In some implementations, the response message indicates a next flyby timer of a satellite for providing service at a location, and the method 1100 further includes: determining a flyby time of the next satellite at the location based on the flyby timer of the satellite. In some implementations, the response message indicates a list of satellites that will be available for providing service at a location, and the method 1100 includes determining a flyby time of the next satellite at the location based on a flyby timer of the satellite.

In some implementations, the method 1100 further includes, based on the list of satellites, transitioning from a non-store and forward mode to a store and forward mode or transitioning from a store and forward mode to a non-store and forward mode.

In some implementations, the response message indicates a list of satellite identifiers that are associated with user equipment (UE) context information.

In some implementations, the method 1100 further includes comparing a broadcast satellite identifier of the satellite to the list of satellite identifiers; and sending the attach request to the satellite when the satellite is represented available in the list of satellite identifiers.

In some implementations, the method 1100 further includes comparing a broadcast satellite identifier of the satellite to the list of satellite identifiers; and sending an updated attach request message when the satellite is not represented in the list of satellite identifiers.

In some implementations, the method 1100 further includes receiving a network-initiated detach request indicating that a satellite link will not be available for more than a threshold amount of time; determining an integrity check for the detach request; and when the integrity check is successful, deactivating radio frequency circuitry for a period of time.

In some implementations, the method 1100 further includes, when a wait timer expires after the period of time has elapsed, sending CPSR data or sending a TAU request to the satellite.

In some implementations, the response message indicates an amount of time a UE can maintain an active service link, and the method 1100 further includes: sending CPSR message including UE data sending short message service information until the amount of time expires.

In some implementations, the response message indicates an amount of time a UE can maintain an active service link, and wherein the method 1100 further includes shutting down radio frequency circuitry once the amount of time expires.

In some implementations, the method 1100 further includes reactivating the radio frequency circuitry when a wait timer expires; and sending CPSR message including UE data sending short message service information to the satellite.

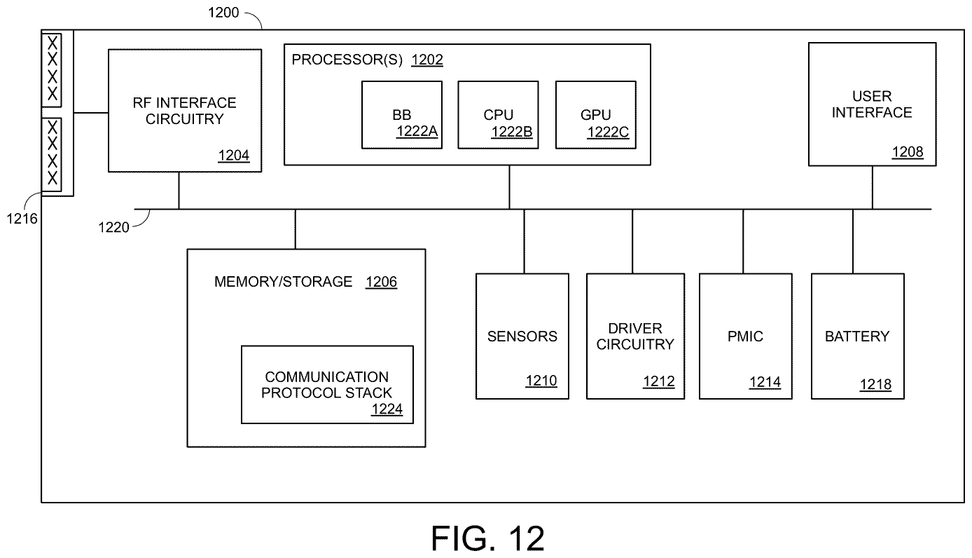

FIG. 12 illustrates an example UE 1200, according to some implementations. The UE 1200 may be similar to and substantially interchangeable with UE 102 of FIG. 1. The UE 1200 may include any mobile or non-mobile computing device, such as, for example, a mobile phone, computer, tablet, industrial wireless sensors, video device (for example, cameras, video cameras, and the like), wearable devices (for example, a smart watch), relaxed internet-of-things (IoT) devices, etc.

The UE 1200 may include any/all of processor 1202, RF interface circuitry 1204, memory/storage 1206, user interface 1208, sensors 1210, driver circuitry 1212, power management integrated circuit (PMIC) 1214, one or more antenna(s) 1216, and battery 1218. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and a different arrangement of the components shown may occur in other implementations.

The components of the UE 1200 may be coupled with various other components over one or more interconnects 1220, which may represent any type of interface, input/output, bus (local, system, or expansion), transmission line, trace, or optical connection that allows various circuit components (on common or different chips or chipsets) to interact with one another.

The processor 1202 may include one or more processors. For example, the processor 1202 may include processor circuitry such as, for example, baseband (BB) processor circuitry 1222A, central processor unit (CPU) circuitry 1222B, and graphics processor unit (GPU) circuitry 1222C. The processor 1202 may include any type of circuitry or processor circuitry that executes or otherwise operates computer-executable instructions, such as program code, software modules, or functional processes from memory/storage 1206 to cause the UE 1200 to perform operations as described herein.

In some implementations, the baseband processor circuitry 1222A may access a communication protocol stack 1224 in the memory/storage 1206 to communicate over a 3GPP compatible network. In general, the baseband processor circuitry 1222A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and/or protocol data unit (PDU) layer; and perform control plane functions at a PHY layer, MAC layer, RLC layer, PDCP layer, RRC layer, and/or non-access stratum (NAS) layer. In some implementations, the PHY layer operations may additionally/alternatively be performed by components of the RF interface circuitry 1204. The baseband processor circuitry 1222A may generate or process baseband signals or waveforms that carry information in 3GPP-compatible networks. In some implementations, waveforms for NR may implement cyclic prefix-orthogonal frequency division multiplexing (CP-OFDM) in the uplink or downlink, and discrete Fourier transform-spread-orthogonal frequency division multiplexing (DFT-S-OFDM) in the uplink.

The memory/storage 1206 may include one or more non-transitory, computer-readable media that includes instructions (for example, communication protocol stack 1224) that can be executed by the processor 1202 to cause the UE 1200 to perform various operations described herein. The memory/storage 1206 include any type of volatile or non-volatile memory that may be distributed throughout the UE 1200. In some implementations, some of the memory/storage 1206 may be located on the processor 1202 itself (for example, Layer 1 “L1” and Layer 2 “L2” caches), while other memory/storage 1206 is external to the processor 1202 but accessible thereto via a memory interface. The memory/storage 1206 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1204 may include transceiver circuitry and radio frequency front end module (RFEM) that allows the UE 1200 to communicate with other devices over a radio access network. The RF interface circuitry 1204 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1216 and proceed to filter and amplify (with a low-noise amplifier) the signal. The signal may be provided to a receiver of the transceiver that downconverts the RF signal into a baseband signal that is provided to the baseband processor.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1216. In various implementations, the RF interface circuitry 1204 may be configured to transmit/receive signals in a manner compatible with NR access technologies.

The antenna(s) 1216 may include one or more antenna elements to convert electrical signals into radio waves to travel through the air and to convert received radio waves over the air into electrical signals. In some implementations, the antenna elements may be arranged into one or more antenna panels. The antenna(s) 1216 may have antenna panels that are omnidirectional, directional, or a combination thereof, to enable beamforming and multiple input, multiple output communications. The antenna(s) 1216 may include any/all of microstrip antennas, printed antennas fabricated on the surface of one or more printed circuit boards, patch antennas, phased array antennas, etc. The antenna(s) 1216 may have one or more panels designed for one or more specific frequency bands, such as bands in frequency range 1 (FR1) or frequency range 2 (FR2).

The user interface 1208 includes various input/output (I/O) devices designed to enable user interaction with the UE 1200. The user interface 1208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors), with the output of characters, graphics, multimedia objects, and the like being generated or produced from the operation of the UE 1200.

The sensors 1210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1212 may include software and hardware elements that operate to control particular devices that are embedded in the UE 1200, attached to the UE 1200, or otherwise communicatively coupled with the UE 1200. The driver circuitry 1212 may include individual drivers allowing other components to interact with or control various I/O devices that may be present within, or connected to, the UE 1200. For example, driver circuitry 1212 may include a display driver to control and allow access to a display device, a touchscreen driver to control and allow access to a touchscreen interface, sensor drivers to obtain sensor readings of sensors 1210 and control and allow access to sensors 1210, drivers to obtain actuator positions of electro-mechanic components or control and allow access to the electro-mechanic components, a camera driver to control and allow access to an embedded image capture device, audio drivers to control and allow access to one or more audio devices.

The PMIC 1214 may manage power provided to various components of the UE 1200. In particular, with respect to the processor 1202, the PMIC 1214 may control power-source selection, voltage scaling, battery charging, or direct current (DC)-to-DC conversion.

In some implementations, the PMIC 1214 may control, or otherwise be part of, various power saving mechanisms of the UE 1200. A battery 1218 may power the UE 1200, although in some examples the UE 1200 may be mounted deployed in a fixed location and may have a power supply coupled to an electrical grid. The battery 1218 may be a lithium ion battery, a metal-air battery, such as a zinc-air battery, an aluminum-air battery, a lithium-air battery, and the like. In some implementations, such as in vehicle-based applications, the battery 1218 may be a lead-acid automotive battery.

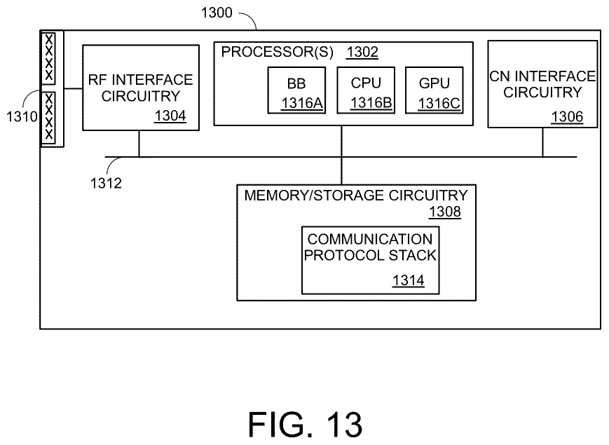

FIG. 13 illustrates an example access node 1300 (e.g., a base station or gNB/eNB), according to some implementations. The access node 1300 may be similar to and substantially interchangeable with base station 104. The access node 1300 may include one or more of processor 1302, RF interface circuitry 1304, core network (CN) interface circuitry 1306, memory/storage circuitry 1308, and one or more antenna(s) 1310. The processor 1302 may include any type of circuitry or processor circuitry that executes or otherwise operates computer-executable instructions, such as program code, software modules, or functional processes from memory/storage circuitry 1308 to cause the access node 1300 to perform operations as described herein.

The components of the access node 1300 may be coupled with various other components over one or more interconnects 1312. The processor 1302, RF interface circuitry 1304, memory/storage circuitry 1308 (including communication protocol stack 1314), antenna(s) 1310, and interconnects 1312 may be similar to like-named elements shown and described with respect to FIG. 13. For example, the processor 1302 may include processor circuitry such as, for example, BB processor circuitry 1316A, CPU circuitry 1316B, and GPU circuitry 1316C.

The CN interface circuitry 1306 may provide connectivity to a core network, for example, a 4G or 5G core (5GC) network using a 5GC-compatible network interface protocol such as carrier Ethernet protocols, or some other suitable protocol. Network connectivity may be provided to/from the access node 1300 via a fiber optic or wireless backhaul. The CN interface circuitry 1306 may include one or more dedicated processors or field-programmable gate arrays (FPGA) to communicate using one or more of the aforementioned protocols. In some implementations, the CN interface circuitry 1306 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as base stations, gNBs, RAN nodes, eNBs, NodeBs, roadside units (RSU), transmit-receive points (TRP), and so forth, and can include ground stations (e.g., terrestrial access points) or satellite stations providing coverage within a geographic area (e.g., a cell). As used herein, the term “NG RAN node” or the like may refer to an access node 1300 that operates in an NR or 5G system (for example, a gNB), and the term “E-UTRAN node” or the like may refer to an access node 1300 that operates in an LTE or 4G system (e.g., an eNB). According to various implementations, the access node 1300 may be implemented as one or more of a dedicated physical device such as a macrocell base station, and/or a low power base station for providing femtocells, picocells or other like cells having smaller coverage areas, smaller user capacity, or higher bandwidth compared to macrocells.

In some implementations, all or parts of the access node 1300 may be implemented as one or more software entities running on server computers as part of a virtual network, which may be referred to as a cloud radio access network (CRAN) and/or a virtual baseband unit pool (vBBUP). In vehicle-to-everything (V2X) scenarios, the access node 1300 may be or act as an RSU. The term RSU refers to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, or the like, as described above in connection with one or more of the preceding figures may be configured to operate in accordance with one or more of the examples set forth below.

### EXAMPLES

Example 1 includes a method comprising receiving, from an access node, an indication of store and forward capability; sending, to a satellite, an attach request message indicating a capability to support store and forward operation and an attach request; and receiving, from the satellite, a response message indicating that the attach request is accepted or that the attach request is rejected.

Example 2 includes the method of example 1, wherein when the attach request is accepted, an attach accept response message includes a store and forward wait timer value, a store and forward event monitor list, and a store and forward delivery time.

Example 3 includes the method of any of examples 1 to 2, wherein when the attach request is rejected, an attach reject response message includes a store and forward wait timer value and a store and forward event monitor list.

Example 4 includes the method of any of examples 1 to 3, further comprising sending, when the attach request is accepted, a tracking area update (TAU) request message, including a TAU request, to the satellite; and receiving a TAU response message indicating that the TAU request is accepted or that the TAU request is rejected.

Example 5 includes the method of any of examples 1 to 4, wherein the satellite includes an onboard mobility management entity (MME) configured to communicate with a ground MME, and wherein the ground MME is configured to perform core network (CN) functionality.

Example 6 includes the method of example 5, wherein the ground MME is configured to update a home subscriber service (HSS) with a location of a user equipment (UE).

Example 7 includes the method of example 5, wherein the ground MME is configured to authenticate a UE.

Example 8 includes the method of example 5, wherein the response message indicates that the attach request, a TAU request, or a CPSR message including device information is rejected because a feeder link is not available within a threshold period of time, and wherein the method further comprises: aborting authentication; and waiting for a store and forward attach timer to expire before attempting to re-attach to a network including the MME.

Example 9 includes the method of example 5, wherein the response message indicates a next fly by time of a satellite for providing service at a location, the method further comprising: determining a flyby time of the next satellite at the location based on the flyby time of the satellite.

Example 10 includes the method of example 5, wherein the response message indicates a list of satellites that will be available for providing service at a location, the method further comprising: determining a flyby time of the next satellite at the location based on a flyby timer of the satellite.

Example 11 includes the method of any of examples 1 to 10, wherein the satellite includes a full evolved packet core (EPC) function.

Example 12 includes the method of example 11, wherein the response message indicates that the attach request, a TAU request, or a CPSR message including device information is rejected because a feeder link is not available within a threshold period of time, and wherein the method further comprises: aborting authentication; and waiting for a store and forward attach timer to expire before attempting to re-attach to a network including the EPC.

Example 13 includes the method of example 11, wherein the response message indicates a next flyby timer of a satellite for providing service at a location, the method further comprising: determining a flyby time of the next satellite at the location based on the flyby timer of the satellite.

Example 14 includes the method of example 11, wherein the response message indicates a list of satellites that will be available for providing service at a location, the method further comprising: determining a flyby time of the next satellite at the location based on a flyby timer of the satellite.

Example 15 includes the method of example 14, further comprising, based on the list of satellites, transitioning from a non-store and forward mode to a store and forward mode or transitioning from a store and forward mode to a non-store and forward mode.

Example 16 includes the method of example 11, wherein the response message indicates a list of satellite identifiers that are associated with user equipment (UE) context information.

Example 17 includes the method of example 17, the method further comprising: comparing a broadcast satellite identifier of the satellite to the list of satellite identifiers; and sending the attach request to the satellite when the satellite is represented available in the list of satellite identifiers.

Example 18 includes the method of example 16, the method further comprising: comparing a broadcast satellite identifier of the satellite to the list of satellite identifiers; and sending an updated attach request message when the satellite is not represented in the list of satellite identifiers.

Example 19 includes the method of any of examples 1 to 18, the method further comprising receiving a network-initiated detach request indicating that a satellite link will not be available for more than a threshold amount of time; determining an integrity check for the detach request; and when the integrity check is successful, deactivating radio frequency circuitry for a period of time.

Example 20 includes the method of example 19, the method further comprising: when a wait timer expires after the period of time has elapsed, sending CPSR data or sending a TAU request to the satellite.

Example 21 includes the method of any of examples 1 to 20, wherein the response message indicates an amount of time a UE can maintain an active service link, and wherein the method further comprises: sending CPSR message including UE data sending short message service information until the amount of time expires.

Example 22 includes the method of any of examples 1 to 21, wherein the response message indicates an amount of time a UE can maintain an active service link, and wherein the method further comprises: shutting down radio frequency circuitry once the amount of time expires.

Example 23 includes the method of example 22, the method further comprising: reactivating the radio frequency circuitry when a wait timer expires; and sending CPSR message including UE data sending short message service information to the satellite.

Example 24 includes an apparatus comprising one or more processors configured to perform the method of any of examples 1-23.

Example 25 includes one or more processors configured to cause radio circuitry to perform the method of any of examples 1-23.

Example 26 includes a method comprising: receiving an attach request message indicating a capability to support store and forward operation and an attach request; and sending a response message indicating that the attach request is accepted or that the attach request is rejected.

Example 27 includes the method of example 26, wherein when the attach request is accepted, the attach accept response message includes a store and forward wait timer value, a store and forward event monitor list, and a store and forward delivery time.

Example 28 includes the method of any of examples 26 or 27, wherein when the attach request is rejected, the attach reject response message includes a store and forward wait timer value and a store and forward event monitor list.

Example 29 includes the method of any of examples 26 to 28, the method further comprising: receiving, when the attach request is accepted, a tracking area update (TAU) request message, including a TAU request; and sending a TAU response message indicating that the TAU request is accepted or that the TAU request is rejected.

Example 30 includes the method of any of examples 26 to 29, wherein a satellite that receives the attach request message includes an onboard mobility management entity (MME) configured to communicate with a ground MME, and wherein the ground MME is configured to perform core network (CN) functionality.

Example 31 includes the method of example 30, wherein the ground MME is configured to update a home subscriber service (HSS) with a location of a user equipment (UE).

Example 32 includes the method of example 30, wherein the ground MME is configured to authenticate a UE.

Example 33 includes the method of example 30, wherein the response message indicates that the attach request, a TAU request, or a CPSR message including device information is rejected because a feeder link is not available within a threshold period of time, and wherein the method further comprises: aborting authentication.

Example 34 includes the method of example 30, wherein the response message indicates a next fly by time of a satellite for providing service at a location.

Example 35 includes the method of example 30, wherein the response message indicates a list of satellites that will be available for providing service at a location.

Example 36 includes the method of any of examples 26 to 35, wherein a satellite that receives the attach request message includes a full evolved packet core (EPC) function.

Example 37 includes the method of example 36, wherein the response message indicates that the attach request, a TAU request, or a CPSR message including device information is rejected because a feeder link is not available within a threshold period of time, and wherein the method further comprises: aborting authentication.

Example 38 includes the method of example 37, wherein the response message indicates a next flyby timer of a satellite for providing service at a location.

Example 39 includes the method of example 37, wherein the response message indicates a list of satellites that will be available for providing service at a location.

Example 40 includes the method of example 37, wherein the response message indicates a list of satellite identifiers that are associated with user equipment (UE) context information.

Example 41 includes the method of any of examples 26 to 40, the method further comprising: sending a network-initiated detach request indicating that a satellite link will not be available for more than a threshold amount of time.

Example 42 includes an apparatus comprising one or more processors configured to perform the method of any of examples 26-41.

Example 43 includes one or more processors configured to cause radio circuitry to perform the method of any of examples 26-41.

Example 44 includes a satellite comprising one or more processors configured to perform the method of any of examples 26-41.

Any of the foregoing examples can be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

As described above, one aspect of the present technology may relate to the gathering and use of data available from specific and legitimate sources to allow for interaction with a second device for a data transfer. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to provide for secure data transfers occurring between a first device and a second device. The personal information data may further be utilized for identifying an account associated with the user from a service provider for completing a data transfer.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For example, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. For example, a user may “opt in” or “opt out” of having information associated with an account of the user stored on a user device and/or shared by the user device. In addition to providing “opt in” and “opt out” options, the present disclosure contemplates providing notifications relating to the access or use of personal information. For example, a user may be notified upon downloading an application that their personal information data will be accessed and then reminded again just before personal information data is accessed by the application. In some instances, the user may be notified upon initiation of a data transfer of the device accessing information associated with the account of the user and/or the sharing of information associated with the account of the user with another device.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

What is claimed is:

1. A method comprising:
receiving, from an access node, an indication of a store and forward capability;
sending, to a satellite, an attach request indicating a capability to support store and forward operation and an attach request; and
receiving, from the satellite, a response indicating that the attach request is accepted or that the attach request is rejected.

2. The method of claim 1, wherein when the attach request is accepted, the response includes a store and forward wait timer value, a store and forward event monitor list, and a store and forward delivery time.

3. The method of claim 1, wherein when the attach request is rejected, the response includes a store and forward wait timer value and a store and forward event monitor list.

4. The method of claim 1, further comprising:
sending, when the attach request is accepted, a tracking area update (TAU) request, including a TAU request, to the satellite; and
receiving a TAU response indicating that the TAU request is accepted or that the TAU request is rejected.

5. The method of claim 1, wherein the satellite includes an onboard mobility management entity (MME) configured to communicate with a ground MME, and wherein the ground MME is configured to perform core network (CN) functionality.

6. The method of claim 5, wherein the ground MME is configured to update a home subscriber service (HSS) with a location of a user equipment (UE).

7. The method of claim 5, wherein the response indicates that the attach request, a TAU request, or a CPSR message including device information is rejected because a feeder link is not available within a threshold period of time, and wherein the method further comprises:
aborting authentication; and
waiting for a store and forward attach timer to expire before attempting to re-attach to a network including the MME.

8. The method of claim 1, wherein the satellite includes a full evolved packet core (EPC) function.

9. The method of claim 8, wherein the response indicates that the attach request, a TAU request, or a CPSR message including device information is rejected because a feeder link is not available within a threshold period of time, and wherein the method further comprises:
aborting authentication; and
waiting for a store and forward attach timer to expire before attempting to re-attach to a network including the EPC.

10. The method of claim 8, wherein the response indicates a list of satellite identifiers that are associated with user equipment (UE) context information.

11. The method of claim 10, further comprising:
comparing a broadcast satellite identifier of the satellite to the list of satellite identifiers; and
sending the attach request to the satellite when the satellite is represented available in the list of satellite identifiers; or
sending an updated attach request when the satellite is not represented in the list of satellite identifiers.

12. The method of claim 1, further comprising:
receiving a network-initiated detach request indicating that a satellite link will not be available for more than a threshold amount of time;
determining an integrity check for the detach request; and
when the integrity check is successful, deactivating radio frequency circuitry for a period of time.

13. The method of claim 1, wherein the response indicates an amount of time a UE can maintain an active service link, and wherein the method further comprises:
sending a CPSR message including UE data sending short message service information until the amount of time expires.

14. The method of claim 1, wherein the response indicates an amount of time a UE can maintain an active service link, and wherein the method further comprises:
shutting down radio frequency circuitry once the amount of time expires.

15. An apparatus comprising:
a memory; and
one or more processors configured to execute instructions stored in the memory for wireless communication, the instructions configured to cause the one or more processors to perform operations comprising:
receiving an attach request indicating a capability to support store and forward operation and an attach request; and
sending a response indicating that the attach request is accepted or that the attach request is rejected.

16. The apparatus of claim 15, wherein when the attach request is accepted, the response includes a store and forward wait timer value, a store and forward event monitor list, and a store and forward delivery time.

17. The apparatus of claim 15, wherein when the attach request is rejected, the response includes a store and forward wait timer value and a store and forward event monitor list.

18. The apparatus of claim 15, further comprising:
receiving, when the attach request is accepted, a tracking area update (TAU) request, including a TAU request; and
sending a TAU response indicating that the TAU request is accepted or that the TAU request is rejected.

19. The apparatus of claim 15, wherein a satellite that receives the attach request includes an onboard mobility management entity (MME) configured to communicate with a ground MME, and wherein the ground MME is configured to perform core network (CN) functionality,
wherein the ground MME is configured to update a home subscriber service (HSS) with a location of a user equipment (UE), or
wherein the ground MME is configured to authenticate a UE.

20. One or more processors configured to cause radio circuitry to perform operations comprising:
receiving, from an access node, an indication of a store and forward capability;
sending, to a satellite, an attach request indicating a capability to support store and forward operation and an attach request; and
receiving, from the satellite, a response indicating that the attach request is accepted or that the attach request is rejected.
